(19) United States
(12) Patent Application Publication
(10) Pub. No.: US 2016/0081298 A1
(43) Pub. Date: Mar. 24, 2016

(54) PET ENCLOSURE WITH CONTROLLABLE INTERIOR ENVIRONMENT

(71) Applicant: Lawrence Baranosky, Edmonton (CA)

(72) Inventor: Lawrence Baranosky, Edmonton (CA)

(21) Appl. No.: 14/495,486

(22) Filed: Sep. 24, 2014

(51) Int. Cl. A01K 1/02

(52) U.S. Cl. CPC A01K 1/0281; A01K 1/0245

(57) ABSTRACT

A pet enclosure having a controllable interior environment. The pet enclosure comprises a head portion, a body portion, a base portion, and cooling means for circulating air throughout the enclosure. The cooling means may include at least one of a thermo-electric air conditioning unit and a plurality of fans and air diffusers. One embodiment includes a carrier for mounting on the trunk of a motorcycle.

### FIELD OF THE INVENTION

The invention relates to pet enclosures having a controllable interior environment.

### BACKGROUND OF THE INVENTION

There currently exists a need for a pet enclosure with a controlled environment. Typical pet enclosures are made of wire, canvas, or plastic that allows air to pass through to cool the animal. However, if the exterior environment is not ideal, due to precipitation, excessive heat, or lack of airflow, the animal inside could face health risks.

One situation where this may occur is transporting an animal in the cargo area of a plane or train. The storage compartment may reach extremely uncomfortable temperatures for the pet, and the airflow throughout the area is not ideal.

Another situation occurs when a motorcycle owner has a need to transport their pet. One type of carrier that is currently used attaches to the rear trunk portion of the motorcycle, but is essentially a wire or plastic kennel, with holes throughout the carrier to allow the animal to both breathe, and to watch their surroundings.

The main problem with this type of carrier is that any type of precipitation would get the animal wet, and quite uncomfortable. Even if there was no rain at the time, there is still the possibility of water being splashed onto the animal by surrounding traffic.

Another type of carrier also is attached to the rear trunk portion, and resembles a piece of luggage, with the animal placed inside and the carrier is zipped closed.

Although this type of carrier will keep the animal dry, the animal is unable to look at the surroundings. An even larger problem is the lack of air-flow through the inside of the carrier, which possibly endangers the health of the animal.

There still remains a need for a pet enclosure with a controlled interior environment, no matter what the state of the exterior environment.

There also remains a need for a pet carrier to be used with a motorcycle that would protect the animal inside from the elements, while still maintaining proper air-flow throughout the inside of the carrier.

### SUMMARY OF THE INVENTION

The present invention is defined by a pet carrier for mounting on a motorcycle which includes a trunk bottom and a trunk lid, the pet carrier comprising an enclosure comprising a head portion, a body portion, and a base portion, and cooling means for circulating air throughout the enclosure, wherein the body portion is dimensioned to fit an animal less than or equal to 25 pounds, and wherein the base portion is removably attached to the motorcycle in place of the trunk lid.

In a preferred embodiment, the cooling means includes a plurality of fans distributed throughout the body portion, wherein with each of the plurality of fans is an air diffuser which can be opened or closed.

In one embodiment, the plurality of fans include a pair of front fans and a pair of rear fans. The pair of front fans can be operated separately from the pair of rear fans.

In a more preferred embodiment, the plurality of fans are battery operated.

In a preferred embodiment, the cooling means includes a thermo-electric air conditioning unit securely mounted in a secondary head portion of the enclosure.

In a preferred embodiment, the head portion includes an opening which is moveable from a closed position to an open position, and wherein the size of the opening is adjustable to allow only the head of the animal to pass through the opening, while preventing the body of the animal from passing through the opening.

In a preferred embodiment, an insert is attached to the opening of the head portion to restrict the size of the opening.

In a preferred embodiment, the body portion of the enclosure is shaped like a dog body and/or the head portion of the enclosure is shaped like a dog head.

In a preferred embodiment, the dog body shape of the enclosure includes four leg sections.

In a more preferred embodiment, one of the plurality of fans and one of the air diffusers is placed inside each of the leg sections. The pair of front fans would be located in front leg sections, while the pair of rear fans is located in rear sections.

In a preferred embodiment, the base portion attaches to the trunk bottom of the motorcycle using standard mounting hardware of the motorcycle.

In a preferred embodiment, the enclosure is made of a polycarbonate material.

In a preferred embodiment, the enclosure is see-through.

In another embodiment of the invention, a pet enclosure comprises a head portion, a body portion, a base portion, and cooling means for circulating air throughout the enclosure; wherein the cooling means includes at least one of: a) a plurality of fans distributed throughout the body portion, wherein with each of the plurality of fans is an air diffuser which can be opened or closed, and b) a thermo-electric air conditioning unit securely mounted in a secondary head portion of the enclosure.

This embodiment could be used for larger animals, and could be used in different types of situations, such as transporting an animal in a cargo area of a plane or train.

Additional characteristics, advantages and functions of the invention will become evident hereinafter from detailed descriptions of examples, in themselves not binding and/or restrictive, of preferential practical embodiments of a pet enclosure having a controllable environment, in accordance with this invention, illustrated by the following drawings.

### BRIEF DESCRIPTION OF THE DRAWINGS

FIG. 1 is a perspective view of the preferred embodiment of a pet carrier for use with a motorcycle, according to the present invention.

FIG. 2 is a front view of the pet carrier of FIG. 1.

FIG. 3 is a top view of the pet carrier of FIG. 1.

FIG. 4 is an end view of the pet carrier of FIG. 1.

FIG. 5 is a perspective view of the pet carrier of FIG. 1, with the head portion in an open position.

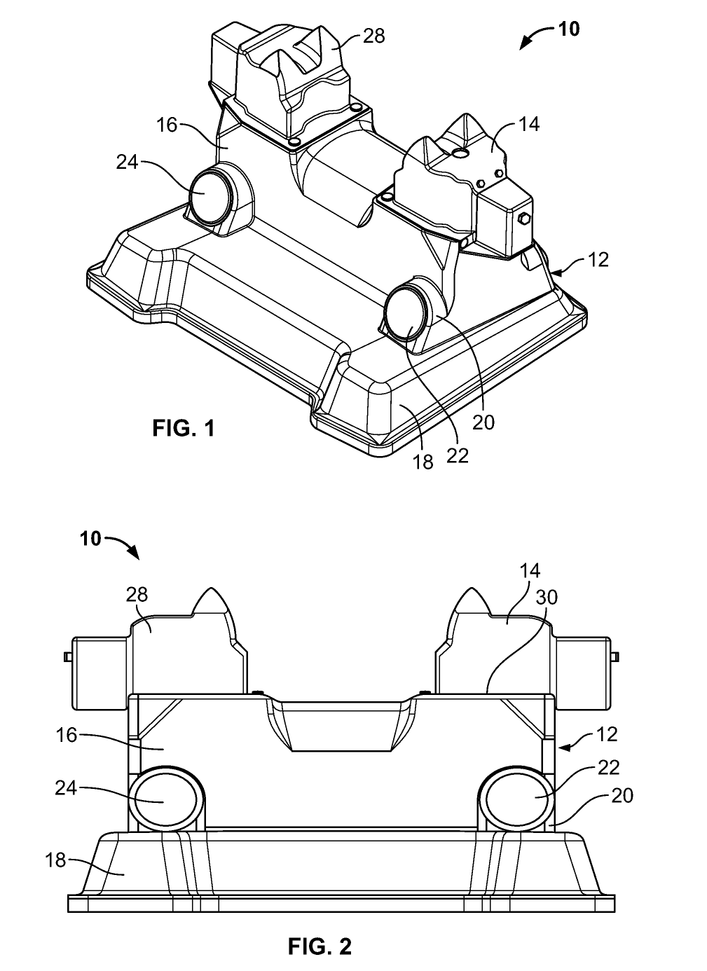

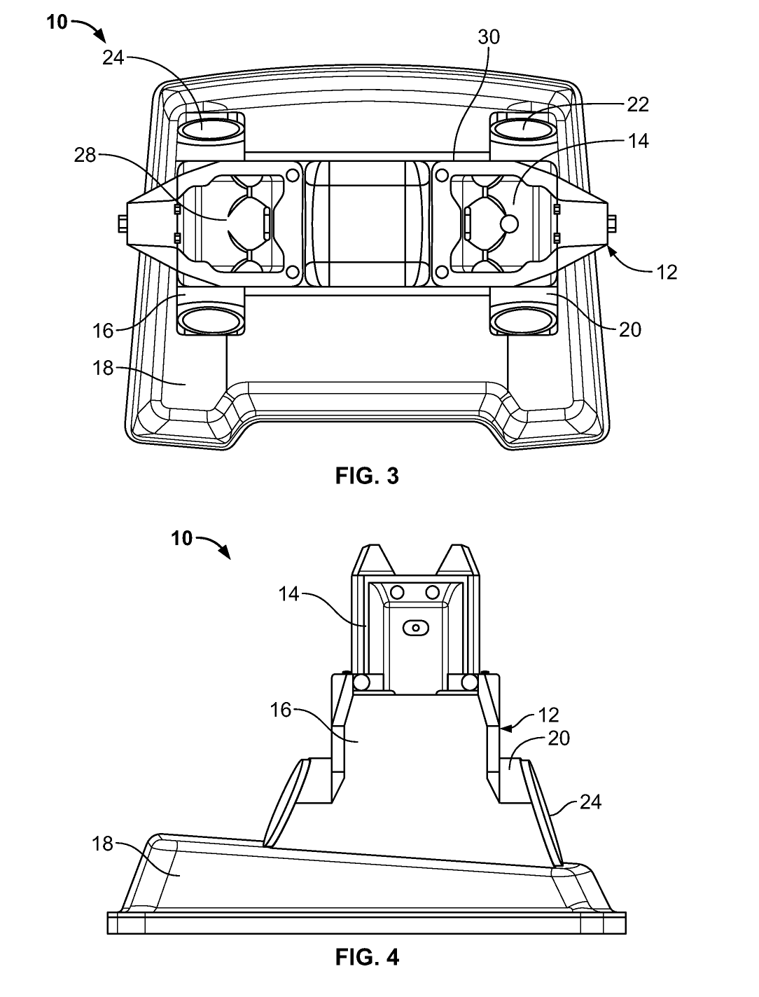

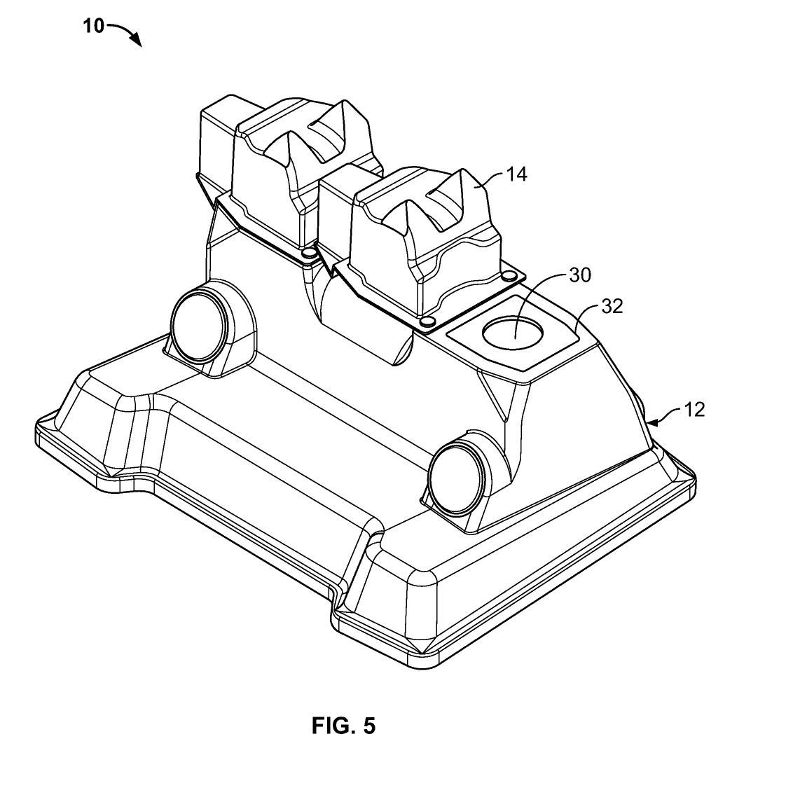

### DETAILED DESCRIPTION OF THE PREFERRED EMBODIMENT

As can be seen in the Figures, a pet carrier 10 is shown, which is designed to be mounted on the rear of a motorcycle (not shown). The pet carrier 10 comprises an enclosure 12, with the enclosure 12 having a head portion 14, a body portion 16, and a base portion 18. In the embodiment shown in the Figures, the enclosure 12 is made of a polycarbonate material, and is shaped like a dog, with the head portion 14 shaped like a dog's head and the body portion 16 is shaped like a dog body, including four leg portions 20. Depending on the level of tint of the polycarbonate material, the animal may be able to see-through the enclosure 12, to enjoy watching the scenery.

The body portion 16 of the enclosure 12 is dimensioned to fit animals, typically dogs. In the preferred embodiment, when the carrier 10 is designed to be mounted on the rear of a motorcycle, the dog can weight up to 25 lbs, in order to not surpass any weight restrictions on the motorcycle. With an alternate embodiment used in a different capacity, such as for travelling in the cargo area of a plane or train, the enclosure 12 could be larger, and no weight restriction on the animal would be required.

In the preferred embodiment, the enclosure 12 is shaped like a dog, but it could alternatively be shaped like a different animal, or any shape altogether that would allow for an animal to fit inside. The benefits of using the shape of a dog for the enclosure 12, includes a reduction of the free space inside the enclosure 12, to prevent the animal from being bounced around inside.

The base portion 18 can be removeably attached to the motorcycle in place of the trunk lid. Typically this can be done by removing the two hinge bolts (not shown) from the motorcycle, and re-using the original trunk lid lock. These hinge bolts allow the enclosure 12 to pivot open, allowing the animal to be placed inside. Alternatively, the animal could be placed in the trunk section prior to the carrier 10 is fastened in place.

In an alternate embodiment that is not attached to a motorcycle, the base portion 18 can be removably attached, or rotatably attached via hinge bolts, to a base plate (not shown), which rests on the ground or floor.

The head portion 14 includes an opening 30 which is able to be moved from an open position to a closed position. FIG. 5 shows the embodiment with the opening 30 in the open position. The size of this opening 30 is dimensioned so that when the opening 30 is in the open position, the head of the animal can extend out of the carrier 10, but the body of the animal cannot. The size of the opening 30 is dimensioned to fit a dog weighing approximately 17-25 lbs. However, the size of the opening 30 can be adjustable, so that a smaller animal is also prevented from jumping out of the opening 30. In this embodiment, the adjustable opening is accomplished by an insert 32 attached to the opening 30. The insert in this embodiment is a piece of Lexan™ having a circular hole in the center of it, shaped to allow the head of the dog to pass through, but not the dog body.

The enclosure 12 is able to keep the animal comfortable by way of cooling means for circulating air throughout the enclosure.

In the embodiment shown in these Figures, the cooling means includes a plurality of fans 22, where each of the fans 22 is countersunk into each of the leg portions 20 along with a corresponding air diffuser 24. This allows for the fans 22 to be safe from both the elements and from the animal.

The fans 22 of this particular embodiment have a draw of 1 amp and operate on a 12 volt system from the fuse box of the motorcycle, or by accessory wiring located under the seat of most touring motorcycles. An alternative option is battery-operated fans. In this embodiment the pair of fans 22 in the front legs can be operated separately from the pair of fans 22 in the rear legs.

As an alternative to, or in addition to, the plurality of fans 22, the cooling means may include a thermo-electric air conditioning (A/C) unit 26, which is located in a secondary head portion 28. The temperature control of the A/C unit 26 can be done by either of two methods: manually or automatically. When controlled automatically, the A/C unit 26 will shut down when the desired temperature is reached, by a thermo-static switch (not shown). The thermo-electric A/C unit 26 can lower the temperature by up to 20° F.

Thus, the carrier 10 keeps the animal cooled at a desired temperature by means of the fans 22 (front fans, rear fans, or both) and/or the A/C unit 26.

The scope of the claims should not be limited by the preferred embodiments set forth in the examples, but should be given the broadest interpretation consistent with the description as a whole.

1. A pet carrier for mounting on a motorcycle which includes a trunk bottom and a trunk lid, the pet carrier comprising:
an enclosure comprising a head portion, a body portion, and a base portion; and
cooling means for circulating air throughout the enclosure;
wherein the body portion is dimensioned to fit an animal less than or equal to 25 pounds; and
wherein the base portion is removably attached to the motorcycle in place of the trunk lid.

2. The pet carrier of claim 1, wherein the cooling means includes a plurality of fans distributed throughout the body portion, wherein with each of the plurality of fans is an air diffuser which can be opened or closed.

3. The pet carrier of claim 2, wherein the plurality of fans are battery operated.

4. The pet carrier of claim 2, wherein the plurality of fans include a pair of front fans and a pair of rear fans.

5. The pet carrier of claim 4, wherein the pair of front fans may be run separately from the pair of rear fans.

6. The pet carrier of claim 1, wherein the cooling means includes a thermo-electric air conditioning unit securely mounted in a secondary head portion of the enclosure.

7. The pet carrier of claim 1, wherein the head portion includes an opening which is moveable from a closed position to an open position, and wherein the size of the opening is adjustable to allow only the head of the animal to pass through the opening, while preventing the body of the animal from passing through the opening.

8. The pet carrier of claim 7, wherein an insert is attached to the opening of the head portion to restrict the size of the opening.

9. The pet carrier of claim 1, wherein the body portion of the enclosure is shaped like a dog body.

10. The pet carrier of claim 1, wherein the head portion of the enclosure is shaped like a dog head.

11. The pet carrier of claim 8, wherein the dog body shape of the enclosure includes four leg sections, wherein one of the plurality of fans and one of the air diffusers is placed inside each of the four leg sections.

12. The pet carrier of claim 11, wherein the four leg sections include a pair of front leg sections and a pair of rear leg sections, with the fans is located in the front leg sections able to be run separately than the fans is located in the rear leg sections.

13. The pet carrier of claim 1, wherein the base portion attaches to the trunk bottom of the motorcycle using standard mounting hardware of the motorcycle.

14. The pet carrier of claim 1, wherein the enclosure is made of a polycarbonate material.

15. The pet carrier of claim 1, wherein the enclosure is see-through.

16. The pet carrier of claim 1, wherein the base portion includes hinge bolts to connect to the motorcycle, which can open the enclosure to allow the animal inside.

17. A pet enclosure, comprising:
a body portion;
a base portion; and
cooling means for circulating air throughout the enclosure;
wherein the cooling means includes at least one of:
a) a plurality of fans distributed throughout the body portion, wherein with each of the plurality of fans is an air diffuser which can be opened or closed, and
b) a thermo-electric air conditioning unit securely mounted in a head portion of the enclosure.
